(19) United States
(12) Patent Application Publication
(10) Pub. No.: US 2022/0357990 A1
(43) Pub. Date: Nov. 10, 2022

(54) METHOD FOR ALLOCATING DATA PROCESSING TASKS, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Dongdong LIU, BEIJING (CN); Haowen Li, BEIJING (CN); Peng Liu, BEIJING (CN); Shuai XIE, BEIJING (CN); Yuchen XUAN, BEIJING (CN)

(21) Appl. No.: 17/871,698

(22) Filed: Jul. 22, 2022

(30) Foreign Application Priority Data
Sep. 29, 2021 (CN) 202111154529.5

(51) Int. Cl. G06F 9/50; G06T 1/20

(52) U.S. Cl. CPC G06F 9/505; G06T 1/20

(57) ABSTRACT

A method for allocating data processing tasks, an electronic device, and a readable storage medium are provided, which relate to the fields of computer vision and artificial intelligence. The method includes: determining a plurality of data processing tasks of a target application for a graphics processor; and allocating, by using a load balancing strategy, the plurality of data processing tasks to a plurality of worker processes created for the target application, wherein the plurality of worker processes are pre-configured with a corresponding graphics processor resource.

### CROSS-REFERENCE TO RELATED APPLICATION

This application claims priority to Chinese patent application No. 202111154529.5, filed on Sep. 29, 2021, which is hereby incorporated by reference in its entirety.

### TECHNICAL FIELD

The present disclosure relates to the field of data processing, and in particular, to data processing and computer vision technologies, which can be specifically used in scenarios such as computer vision, artificial intelligence and the like.

### BACKGROUND

A Graphics Processing Unit (GPU) is a microprocessor for processing data processing tasks related to images and graphics. Due to the super-strong computing power of GPUs, the GPUs play an important role in fields that require high-performance computing, such as artificial intelligence and the like.

### SUMMARY

The present disclosure provides a method and apparatus for allocating data processing tasks, an electronic device, a readable storage medium, and a computer program product, to improve the utilization rate of the GPU resource.

According to an aspect of the present disclosure, there is provided a method for allocating data processing tasks, which can include:

determining a plurality of data processing tasks of a target application for a graphics processor; and

allocating, by using a load balancing strategy, the plurality of data processing tasks to a plurality of worker processes created for the target application, wherein the plurality of worker processes are pre-configured with a corresponding graphics processor resource.

According to another aspect of the present disclosure, there is provided an electronic device, which includes:

at least one processor, and

a memory communicatively connected with the at least one processor, wherein

the memory stores instructions executable by the at least one processor, and the instructions, when executed by the at least one processor, enable the at least one processor to perform the method in any embodiment of the present disclosure.

According to another aspect of the present disclosure, there is provided a non-transitory computer-readable storage medium storing computer instructions, wherein the computer instructions, when executed by a computer, cause the computer to perform the method in any embodiment of the present disclosure.

It should be understood that the content described in this section is neither intended to limit the key or important features of the embodiments of the present disclosure, nor intended to limit the scope of the present disclosure. Other features of the present disclosure will be readily understood through the following description.

### BRIEF DESCRIPTION OF THE DRAWINGS

The drawings are used to better understand the solution and do not constitute a limitation to the present disclosure, wherein:

FIG. 1 is a flowchart of a method for allocating data processing tasks according to an embodiment of the present disclosure;

FIG. 2 is a schematic diagram of a Client-Server (CS) architecture provided by an embodiment of the present disclosure:

FIG. 3 is a flowchart of a method for allocating graphics processor resources provided in an embodiment of the present disclosure;

FIG. 4 is a flowchart of a method for creating a worker process provided in an embodiment of the present disclosure;

FIG. 5 is a schematic diagram of an apparatus for allocating data processing tasks provided by an embodiment of the present disclosure; and

FIG. 6 is a schematic diagram of an electronic device provided by an embodiment of the present disclosure.

### DETAILED DESCRIPTION

Exemplary embodiments of the present disclosure are described below in combination with the drawings, including various details of the embodiments of the present disclosure to facilitate understanding, which should be considered as exemplary only. Thus, those of ordinary skill in the art should realize that various changes and modifications can be made to the embodiments described here without departing from the scope and spirit of the present disclosure. Likewise, descriptions of well-known functions and structures are omitted in the following description for clarity and conciseness.

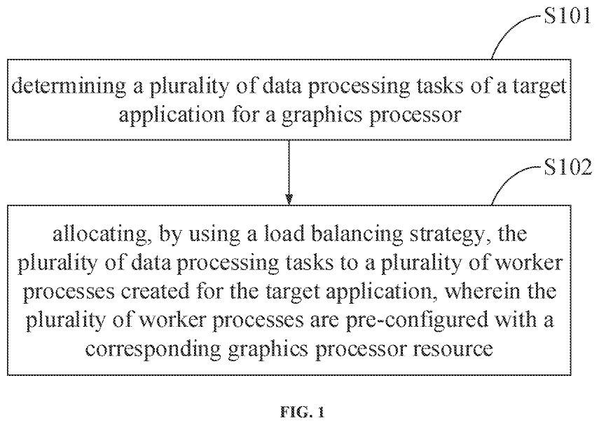

The present disclosure provides a method for allocating data processing tasks. For details, please refer to FIG. 1, which is a flowchart of a method for allocating data processing tasks provided by an embodiment of the present disclosure. The method can include:

S101: determining a plurality of data processing tasks of a target application for a graphics processor.

S102: allocating, by using a load balancing strategy, the plurality of data processing tasks to a plurality of worker processes created for the target application, wherein the plurality of worker processes are pre-configured with a corresponding graphics processor resource.

In the method for allocating data processing tasks provided in the embodiment of the present disclosure, the execution subject is generally a computing device running a target application. The so-called target application can include an application that requires a graphics processor to support running. Specifically, the target application can include an application under a Platform as a Service (PaaS) platform, and can also include an application with an image processing function.

The so-called computing device includes but is not limited to mobile phones, computers, servers, or server clusters.

The PaaS platform is taken as an example. For the PaaS platform, the PaaS platform controls the GPU resources in a large granularity, and it is difficult to perform resource normalization management on the GPU resources under the PaaS platform, and thus a finer-grained resource allocation cannot be performed on the GPU resources under the PaaS platform, thereby requiring the full utilization of the GPU resources to reduce resource costs. Therefore, improving the utilization rate of the graphics processor resources is of great significance for the use of GPUs. In the prior art, there is the situation that a plurality of threads cannot use a GPU concurrently or even a plurality of threads in a single GPU cannot use the GPU concurrently, which causes the problem of low utilization rate of GPU resources.

The method for allocating data processing tasks provided by the embodiment of the present disclosure can use the load balancing strategy to allocate the plurality of data processing tasks for the graphics processor to the plurality of worker processes pre-configured with corresponding graphics processor resource. Therefore, the plurality of worker processes can use the graphics processor resource concurrently, thereby improving the utilization rate of the graphics processor resource.

The so-called GPU resources generally include but are not limited to GPU computing power and graphics card memories. The so-called GPU computing power includes but is not limited to running memories.

The so-called data processing tasks for the graphics processor refer to data processing that can only be completed by using a GPU, and generally include data processing tasks related to images and graphics.

The so-called worker process is a process created for the target application, and is used to execute the data processing tasks of the target application for the graphics processor when the application is running.

The so-called load balancing strategy refers to balancing and apportioning data processing tasks (loads) to a plurality of worker processes for execution, thereby realizing the concurrent execution strategy of a plurality of data processing tasks.

Common load balancing strategies include a variety of strategies, such as a polling strategy, a random strategy, and a least connection strategy. However, the implementation process of the polling strategy is relatively simple, and it is a load balancing strategy that does not need to record the current working states of all processes. Therefore, in the embodiment of the present disclosure, the specific implementation of allocating, by using a load balancing strategy, the plurality of data processing tasks to a plurality of worker processes created for the target application generally includes: allocating, by using a polling strategy, the plurality of data processing tasks to the plurality of worker processes according to a task generation sequence corresponding to the plurality of data processing tasks.

In addition, in order to improve the applicability of the load balancing strategy, the load balancing strategy in the embodiment of the present disclosure can also be a load balancing strategy self-defined by a relevant user according to data processing tasks corresponding to a business scenario.

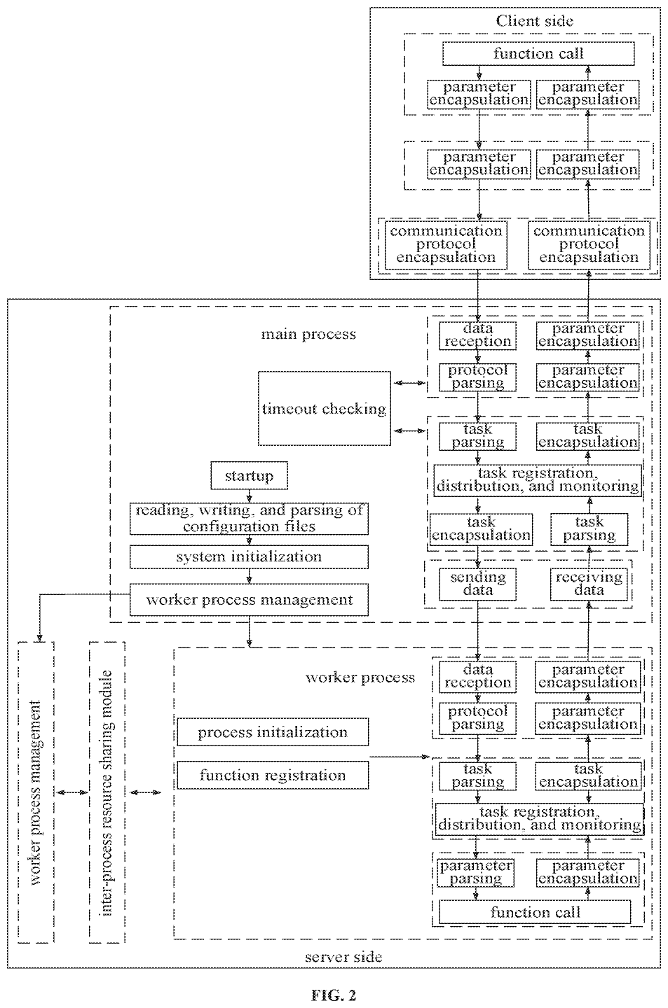

The method for allocating data processing tasks provided by the embodiment of the present disclosure can be implemented by adopting a Client-Server (CS) architecture in a specific implementation process. For details, please refer to FIG. 2. FIG. 2 is a schematic diagram of a CS architecture provided by an embodiment of the present disclosure.

In the embodiment of the present disclosure, the Client side refers to a component or program, provided in an operating system, for data transmission and reception, and is specifically configured for acquiring an application service request, for a graphics processor, issued by a target application; splitting the application service request into a plurality of data processing tasks according to a predetermined splitting rule, and sending the data processing tasks to the corresponding Server side.

The Client side can specifically perform at least the following works: function call, parameter encapsulation, task encapsulation, and communication protocol encapsulation.

The Server side is a component or program used for data processing task allocation, data processing task execution, and data processing task result forwarding. The server side specifically adopts a master-worker (master-slave) mode. The master is a main process responsible for communicating with the client and then sending the data processing tasks to the corresponding worker. The main process can at least perform the following works: startup of the worker process, reading, writing, and parsing of configuration files, system initialization, worker process management, data reception, protocol parsing, task parsing, task registration, task distribution, task monitoring, task encapsulation, protocol encapsulation, sending data, and timeout checking.

The Worker is a worker process responsible for the execution of specific data processing tasks. The worker process can at least perform the following works: process initialization, function registration, receiving data, sending data, task parsing, task encapsulation, task monitoring, parameter parsing, parameter encapsulation, and function call. There are a plurality of worker processes in the embodiment of the present disclosure. FIG. 2 shows only two worker processes, and only shows the data interaction process between the main process and the worker process based on one of the worker processes. In addition, the inter-process resource sharing module in FIG. 2 is a pre-configured module for supporting the sharing of resources such as the GPU, the CPU, the graphics card memory, and the video memory among worker processes.

Please refer to FIG. 2 for details on the sequence between the above executable tasks in the Server side and the Client side.

If the application service request is not split into tasks, the program needs to perform different tasks in sequence to realize the service request. However, some operations can be split into a plurality of data processing tasks to be executed in parallel, so that the response speed of the service request can be improved. For example, for the extraction of image features, a plurality of data processing tasks obtained by splitting the feature extraction of a plurality of sub-images of the image can be processed in parallel, so that the response speed of the extraction can be improved.

The so-called predetermined splitting rule generally includes splitting an application service request into a plurality of data processing tasks according to the type of the application service request. For example, for the service request with the type of image feature extraction, the image feature extraction service request can be split into image feature extraction tasks for different image regions. The so-called image regions refer to regions obtained by splitting an image.

As another example, for the service request for the training type of the image processing network model, the model training service request can be split into training tasks for a plurality of sub-models.

The so-called predetermined splitting rule can further include dividing the application service request into a plurality of execution operations in sequence, and then dividing each execution into a plurality of data processing tasks.

Taking the CS architecture to realize the method for allocating data processing tasks as an example, after the Client side receives the application service request, the Client side will split the application service request into a plurality of data processing tasks according to the predetermined splitting rule. Afterwards, the task processing request parameter encapsulation, task encapsulation, and communication protocol encapsulation can generally be performed by means of function call, thereby generating data carrying the data processing tasks and forwarding it to the Server side.

For data processing tasks related to a session control (session), the Session object stores attributes and configuration information required for a specific user session, and variables stored in the Session object will not disappear immediately after the current task ends, but it will continue to exist for a certain period of time, thereby ensuring that the variables in the Session object can be used directly when the process is used again. Therefore, when there are data processing tasks, related to a session control, of a plurality of data processing tasks, the data processing tasks related to the session control all can be allocated to a designated worker process for processing.

The so-called designated worker process can be a pre-configured worker process that can be used to process data processing tasks related to the session control. It can also be a worker process that is executing the data processing tasks related to the session control or has executed the data processing tasks related to the session control within a designated time interval.

Taking the CS architecture to realize the method for allocating data processing tasks as an example, please refer to FIG. 2 again. The communication protocol between the Client side and the Server side generally includes a Remote Procedure Call (PRC) protocol, to assign the session control to the PRC protocol, so that the Client side can directly allocate data processing tasks related to the session control to the designated worker process.

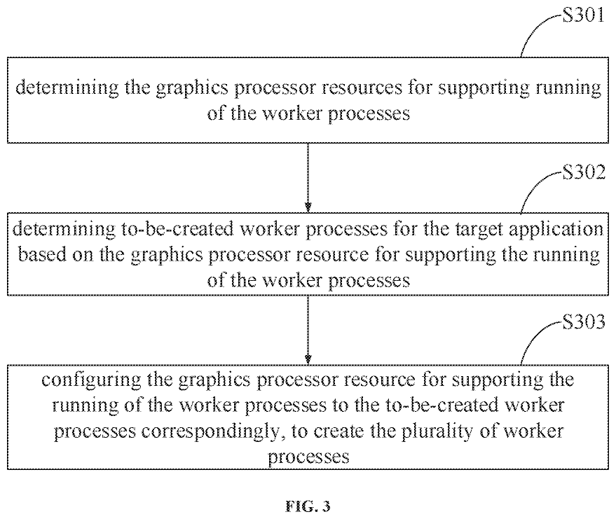

Before allocating the plurality of data processing tasks to the plurality of worker processes created for the target application, the plurality of worker processes need to be created first. For specific implementation operations, please refer to FIG. 3. FIG. 3 is a flowchart of a method for allocating a graphics processor resource provided in an embodiment of the present disclosure.

S301: determining the graphics processor resource for supporting running of the worker processes.

S302: determining to-be-created worker processes for the target application based on the graphics processor resource for supporting the running of the worker processes.

S303: configuring the graphics processor resource for supporting the running of the worker processes to the to-be-created worker processes correspondingly, to create the plurality of worker processes.

For different applications, the workload of data processing and the demand for resources can be different. On the basis of determining the graphics processor resource for supporting the running of the worker processes, the to-be-created worker processes are determined for different applications, and the graphics processor resource is correspondingly configured to the to-be-created worker processes, to create a plurality of worker processes, so that the utilization rate of the GPU by the target application can be improved.

The so-called graphics processor resource for supporting the running of the worker processes refers to the graphics processor resource, which can be used for supporting the running of the worker processes, of the idle graphics processor resources. Taking the GPU running memory as an example, if the running memory is 8G, the running memory for supporting the running of the worker processes is generally about 6G.

The so-called determining the to-be-created worker processes can include: determining the number of the to-be-created worker processes, and determining the graphics processor resource allocated correspondingly to the to-be-created worker processes. That is to say, the implementation of determining the to-be-created worker processes includes: determining the number of the to-be-created worker processes, and determining the graphics processor resource allocated to each worker process.

In a specific implementation process, the so-called number of the to-be-created worker processes and the graphics processor resource allocated to each worker process is generally the number of processes that can enable the target application to have the highest utilization rate of the GPU resource and the graphics processor resource allocated to each worker process, determined after adjustment of a plurality of times for the target application and the graphics processor resource allocated to each worker process.

After determining the number with the highest utilization rate of the GPU resource and the graphics processor resource allocated to each worker process, the number with the highest utilization rate can be used as the final number; and the graphics processor resource can be allocated to each worker process. The above final number and the graphics processor resource allocated to each worker process are stored. In the process of creating the plurality of worker processes, the final number and the graphics processor resource allocated to each worker process can be directly acquired, and determined as the number of the to-be-created worker processes and the graphics processor resource allocated to each worker process.

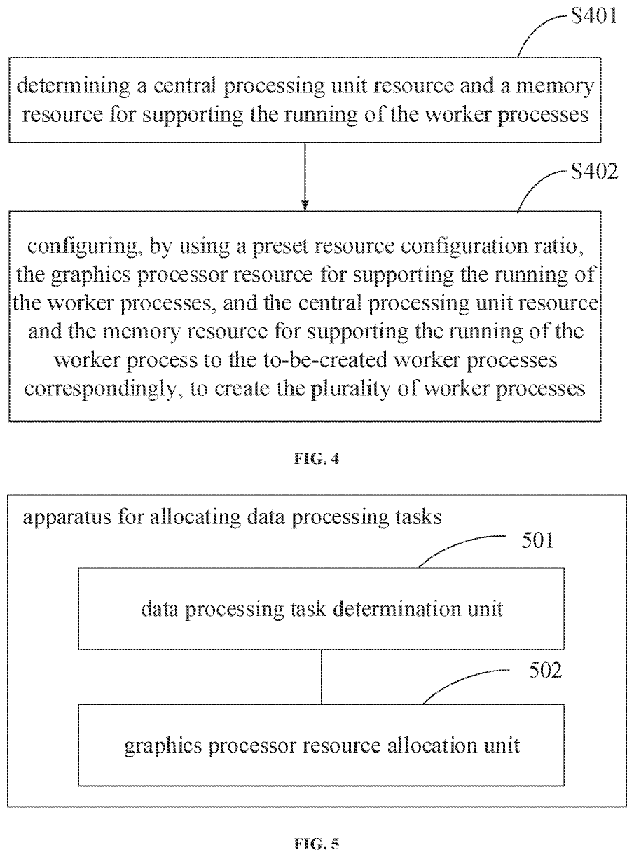

It should be noted that, the worker process requires not only the support of the GPU resource, but also the support of the Central Processing Unit (CPU) resource and the memory resource during the running process. Therefore, creating a worker process can be further implemented according to the following operations. For details, please refer to FIG. 4. FIG. 4 is a flowchart of a method for creating a worker process provided in an embodiment of the present disclosure.

S401: determining a central processing unit resource and a memory resource for supporting the running of the worker processes.

S402: configuring, by using a preset resource configuration ratio, the graphics processor resource for supporting the running of the worker processes, and the central processing unit resource and the memory resource for supporting the running of the worker process to the to-be-created worker processes correspondingly, to create the plurality of worker processes.

It should be noted that the preset resource configuration ratio is a resource configuration ratio among the graphics processor resource, the central processing unit resource, and the memory resource.

Since the use costs of the GPU resource is often higher than the use costs of the CPU resource and the memory resource, on the basis of determining the graphics processor resource allocated to each worker process, the central processing unit resource and the memory resource allocated to each worker process are further determined. It can reduce the overall costs of running the worker processes while ensuring the high utilization rate of the GPU resource.

In the embodiment of the present disclosure, the specific implementation of determining the central processing unit resource and the memory resource allocated correspondingly to the to-be-created worker processes includes: determining the central processing unit resource and the memory resources allocated to each worker process based on the graphics processor resource allocated to each worker process, according to the resource configuration ratio among the graphics processor resource, the central processing unit resource, and the memory resource.

The so-called preset resource configuration ratio among the central processing unit resource, the memory resource, and the graphics processor resource is generally a resource configuration ratio that enables the target application to have the highest utilization rate of the GPU resource and makes the resource costs relatively low, determined based on the continuous adjusting of the resource configuration ratio among the graphics processor resource, the central processing unit resource, and the memory resource.

It should be noted that while ensuring the high utilization rate of the GPU resource, it is also necessary to consider the CPU resource and the memory available to support the running of worker processes. That is to say, on the basis of ensuring that the CPU resource and the memory can support the worker processes, the high utilization rate of the GPU resource is ensured.

For video memory, in order to improve the efficiency of communication between different processes and improve the execution efficiency of the worker processes, a shared memory can be determined when configuring the memory that supports the running of worker processes. The shared memory is a memory which is shared among respective worker processes.

In addition, in order to improve the efficiency of communication between different processes, and improve the execution efficiency of the worker processes, in the case where the graphics processor resource that can be used for supporting the running of the processes includes the graphics card memory, the specific implementation of configuring the graphics processor resource for supporting the running of the worker processes to the to-be-created worker processes correspondingly can include: first, determining a shared graphics card memory allocated for the to-be-created worker processes, wherein the shared graphics card memory is a graphics card memory used for being shared between respective worker processes; then, configuring the shared graphics card memory to the to-be-created worker processes.

Herein, the shared graphics card memory can support different worker processes to access shared data.

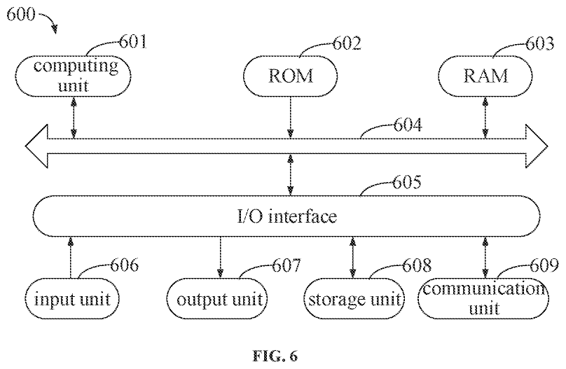

As shown in FIG. 5, an embodiment of the present disclosure provides an apparatus for allocating data processing tasks, which includes:

a data processing task determination unit 501, configured for determining a plurality of data processing tasks of a target application for a graphics processor, and

a graphics processor resource allocation unit 502, configured for allocating, by using a load balancing strategy, the plurality of data processing tasks to a plurality of worker processes created for the target application, wherein the plurality of worker processes are pre-configured with a corresponding graphics processor resource.

In an implementation, the graphics processor resource allocation unit 502 can include:

a first task allocation subunit, configured for allocating, by using a polling strategy, the plurality of data processing tasks to the plurality of worker processes according to a task generation sequence corresponding to the plurality of data processing tasks.

In an implementation, the data processing task determining unit 501 can include: a first task determination subunit, configured for determining a data processing task, related to a session control, of the plurality of data processing tasks; and

the graphics processor resource allocation unit 502 can include:

a second task allocation subunit, configured for allocating the data processing task related to the session control to a designated worker process among the plurality of worker processes.

In an implementation, the data processing task determination unit 501 can include:

an application service request acquisition subunit, configured for acquiring an application service request, for the graphics processor, sent by the target application; and

a data processing task splitting subunit, configured for splitting the application service request into the plurality of data processing tasks according to a predetermined splitting rule.

In an implementation, the apparatus can further include:

a first resource determination unit, configured for, before allocating the plurality of data processing tasks to the plurality of worker processes created for the target application, determining the graphics processor resource for supporting running of the worker processes;

a to-be-created worker process determination unit, configured for determining to-be-created worker processes for the target application based on the graphics processor resource for supporting the running of the worker processes; and

a resource configuration unit, configured for configuring the graphics processor resource for supporting the running of the worker processes to the to-be-created worker processes correspondingly, to create the plurality of worker processes.

In an implementation, the resource configuration unit can include:

a shared graphics card memory determination subunit, configured for, in a case where the graphics processor resource for supporting the running of the worker processes includes a graphics card memory, determining a shared graphics card memory allocated for the to-be-created worker processes, wherein the shared graphics card memory is a graphics card memory used for being shared between the respective worker processes; and

a shared graphics card memory configuration subunit, configured for configuring the shared graphics card memory to the to-be-created worker processes.

In an implementation, the apparatus can further include:

a second resource determination unit, configured for determining a central processing unit resource and a memory resource for supporting the running of the worker processes, and

a process creation unit, configured for configuring, by using a preset resource configuration ratio, the graphics processor resource for supporting the running of the worker processes, and the central processing unit resource and the memory resource for supporting the running of the worker process to the to-be-created worker processes correspondingly, to create the plurality of worker processes,

wherein the preset resource configuration ratio is a resource configuration ratio between the graphics processor resource and the central processing unit resources and the memory resource.

According to embodiments of the present disclosure, the present disclosure also provides an electronic device and a readable storage medium.

FIG. 6 shows a schematic diagram of an example electronic device 600 configured for implementing the embodiment of the present disclosure. The electronic device is intended to represent various forms of digital computers, such as laptop computers, desktop computers, workstations, personal digital assistants, servers, blade servers, mainframe computers, and other suitable computers. The electronic device can also represent various forms of mobile devices, such as a personal digital assistant, a cellular telephone, a smart phone, a wearable device, and other similar computing devices. The components shown herein, their connections and relationships, and their functions are by way of example only and are not intended to limit the implementations of the present disclosure described and/or claimed herein.

As shown in FIG. 6, the electronic device 600 includes a computing unit 601 that can perform various suitable actions and processes in accordance with computer programs stored in a read only memory (ROM) 602 or computer programs loaded from a storage unit 608 into a random access memory (RAM) 603. In the RAM 603, various programs and data required for the operation of the electronic device 600 can also be stored. The computing unit 601, the ROM 602, and the RAM 603 are connected to each other through a bus 604. An input/output (IO) interface 605 is also connected to the bus 604.

A plurality of components in the electronic device 600 are connected to the I/O interface 605, including: an input unit 606, such as a keyboard, a mouse, etc.; an output unit 607, such as various types of displays, speakers, etc.; a storage unit 608, such as a magnetic disk, an optical disk, etc.; and a communication unit 609, such as a network card, a modem, a wireless communication transceiver, etc. The communication unit 609 allows the electronic device 600 to exchange information/data with other devices over a computer network, such as the Internet, and/or various telecommunications networks.

The computing unit 601 can be various general purpose and/or special purpose processing assemblies or programs having processing and computing capabilities. Some examples of the computing unit 601 include, but are not limited to, a central processing unit (CPU), a graphics processing unit (GPU), various specialized artificial intelligence (AI) computing chips, various computing units running machine learning model algorithms, a digital signal processor (DSP), and any suitable processor, controller, microcontroller, etc. The computing unit 601 performs various methods and processes described above, such as the method for allocating data processing tasks. For example, in some embodiments, the method for allocating data processing tasks can be implemented as a computer software program that is physically contained in a machine-readable medium, such as the storage unit 608. In some embodiments, a part or all of the computer program can be loaded into and/or installed on the electronic device 600 via the ROM 602 and/or the communication unit 609. In a case where the computer programs are loaded into the RAM 603 and executed by the computing unit 601, one or more of operations of the method for allocating data processing tasks can be performed. Alternatively, in other embodiments, the computing unit 601 can be configured to perform the method for allocating data processing tasks in any other suitable manner (e.g., by means of a firmware).

Various implementations of the systems and techniques described herein above can be implemented in a digital electronic circuit system, an integrated circuit system, a field programmable gate array (FPGA), an application specific integrated circuit (ASIC), an application specific standard product (ASSP), a system on a chip (SOC), a load programmable logic device (CPLD), a computer hardware, firmware, software, and/or a combination thereof. These various implementations can include an implementation in one or more computer programs, which can be executed and/or interpreted on a programmable system including at least one programmable processor, the programmable processor can be a dedicated or general-purpose programmable processor and capable of receiving and transmitting data and instructions from and to a storage system, at least one input device, and at least one output device.

The program codes for implementing the method of the present disclosure can be written in any combination of one or more programming languages. These program codes can be provided to a processor or controller of a general purpose computer, a special purpose computer, or other programmable data processing apparatus such that the program codes, when executed by the processor or controller, enable the functions/operations specified in the flowchart and/or the block diagram to be performed. The program codes can be executed entirely on a machine, partly on a machine, partly on a machine as a stand-alone software package and partly on a remote machine, or entirely on a remote machine or server.

In the context of the present disclosure, the machine-readable medium can be a tangible medium that can contain or store programs for using by or in connection with an instruction execution system, apparatus or device. The machine-readable medium can be a machine-readable signal medium or a machine-readable storage medium. The machine-readable medium can include, but is not limited to, an electronic, magnetic, optical, electromagnetic, infrared, or semiconductor system, apparatus or device, or any suitable combination thereof. More specific examples of the machine-readable storage medium can include one or more wire-based electrical connection, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination thereof.

In order to provide an interaction with a user, the system and technology described here can be implemented on a computer having: a display device (e.g., a cathode ray tube (CRT) or a liquid crystal display (LCD) monitor) for displaying information to the user; and a keyboard and a pointing device (e.g., a mouse or a trackball), through which the user can provide an input to the computer. Other kinds of devices can also provide an interaction with the user. For example, a feedback provided to the user can be any form of sensory feedback (e.g., visual feedback, auditory feedback, or tactile feedback); and an input from the user can be received in any form (including an acoustic input, a voice input or a tactile input).

The systems and techniques described herein can be implemented in a computing system (e.g., as a data server) that includes a background component, or a computing system (e.g., an application server) that includes a middleware component, or a computing system (e.g., a user computer having a graphical user interface or a web browser through which a user can interact with implementations of the systems and techniques described herein) that includes a front-end component, or a computing system that includes any combination of such a background component, middleware component, or front-end component. The components of the system can be connected to each other through a digital data communication in any form or medium (e.g., a communication network). Examples of the communication network include a local area network (LAN), a wide area network (WAN), and the Internet.

The computer system can include a client and a server. The client and the server are typically remote from each other and typically interact via the communication network. The relationship of the client and the server is generated by computer programs running on respective computers and having a client-server relationship with each other. The server can be a cloud server, a distributed system server, or a server combined with a blockchain.

It should be understood that the operations can be reordered, added, or deleted using the various flows illustrated above. For example, various operations described in the present disclosure can be performed concurrently, sequentially or in a different order, so long as the desired results of the technical solutions provided in the present disclosure can be achieved, and there is no limitation herein.

The above-described specific implementations do not limit the protection scope of the present disclosure. It will be apparent to those skilled in the art that various modifications, combinations, sub-combinations, and substitutions are possible, depending on design requirements and other factors. Any modifications, equivalent substitutions, and improvements within the spirit and principles of the present disclosure are intended to be included within the protection scope of the present disclosure.

What is claimed is:

1. A method for allocating data processing tasks, comprising:
determining a plurality of data processing tasks of a target application for a graphics processor; and
allocating, by using a load balancing strategy, the plurality of data processing tasks to a plurality of worker processes created for the target application, wherein the plurality of worker processes are pre-configured with a corresponding graphics processor resource.

2. The method of claim 1, wherein the allocating, by using the load balancing strategy, the plurality of data processing tasks to the plurality of worker processes created for the target application, comprises:
allocating, by using a polling strategy, the plurality of data processing tasks to the plurality of worker processes according to a task generation sequence corresponding to the plurality of data processing tasks.

3. The method of claim 1, wherein the determining the plurality of data processing tasks of the target application for the graphics processor, comprises: determining a data processing task, related to a session control, of the plurality of data processing tasks; and
the allocating the plurality of data processing tasks to the plurality of worker processes created for the target application, comprises:
allocating the data processing task related to the session control to a designated worker process among the plurality of worker processes.

4. The method of claim 1, wherein the determining the plurality of data processing tasks of the target application for the graphics processor, comprises:
acquiring an application service request, for the graphics processor, sent by the target application; and
splitting the application service request into the plurality of data processing tasks according to a predetermined splitting rule.

5. The method of claim 1, wherein, before allocating the plurality of data processing tasks to the plurality of worker processes created for the target application, the method further comprises:
determining the graphics processor resource for supporting running of the worker processes;
determining to-be-created worker processes for the target application based on the graphics processor resource for supporting the running of the worker processes; and
configuring the graphics processor resource for supporting the running of the worker processes to the to-be-created worker processes correspondingly, to create the plurality of worker processes.

6. The method of claim 5, wherein in a case where the graphics processor resource for supporting the running of the worker processes comprises a graphics card memory, the configuring the graphics processor resource for supporting the running of the worker processes to the to-be-created worker processes correspondingly, comprises:
determining a shared graphics card memory allocated for the to-be-created worker processes, wherein the shared graphics card memory is a graphics card memory used for being shared between respective worker processes; and
configuring the shared graphics card memory to the to-be-created worker processes.

7. The method of claim 5, wherein the creating the plurality of worker processes, comprises:
determining a central processing unit resource and a memory resource for supporting the running of the worker processes; and
configuring, by using a preset resource configuration ratio, the graphics processor resource for supporting the running of the worker processes, and the central processing unit resource and the memory resource for supporting the running of the worker process to the to-be-created worker processes correspondingly, to create the plurality of worker processes,
wherein the preset resource configuration ratio is a resource configuration ratio between the graphics processor resource and the central processing unit resources and the memory resource.

8. An electronic device, comprising:
at least one processor; and
a memory communicatively connected with the at least one processor, wherein
the memory stores instructions executable by the at least one processor, and the instructions, when executed by the at least one processor, enable the at least one processor to perform operations of:
determining a plurality of data processing tasks of a target application for a graphics processor; and
allocating, by using a load balancing strategy, the plurality of data processing tasks to a plurality of worker processes created for the target application, wherein the plurality of worker processes are pre-configured with a corresponding graphics processor resource.

9. The electronic device of claim 8, wherein the allocating, by using the load balancing strategy, the plurality of data processing tasks to the plurality of worker processes created for the target application, comprises:
allocating, by using a polling strategy, the plurality of data processing tasks to the plurality of worker processes according to a task generation sequence corresponding to the plurality of data processing tasks.

10. The electronic device of claim 8, wherein the determining the plurality of data processing tasks of the target application for the graphics processor, comprises:
determining a data processing task, related to a session control, of the plurality of data processing tasks; and
the allocating the plurality of data processing tasks to the plurality of worker processes created for the target application, comprises:
allocating the data processing task related to the session control to a designated worker process among the plurality of worker processes.

11. The electronic device of claim 8, wherein the determining the plurality of data processing tasks of the target application for the graphics processor, comprises:
acquiring an application service request, for the graphics processor, sent by the target application; and
splitting the application service request into the plurality of data processing tasks according to a predetermined splitting rule.

12. The electronic device of claim 8, wherein before allocating the plurality of data processing tasks to the plurality of worker processes created for the target application, the instructions, when executed by the at least one processor, enable the at least one processor to perform further operations of:
determining the graphics processor resource for supporting running of the worker processes;
determining to-be-created worker processes for the target application based on the graphics processor resource for supporting the running of the worker processes; and
configuring the graphics processor resource for supporting the running of the worker processes to the to-be-created worker processes correspondingly, to create the plurality of worker processes.

13. The electronic device of claim 12, wherein in a case where the graphics processor resource for supporting the running of the worker processes comprises a graphics card memory, the configuring the graphics processor resource for supporting the running of the worker processes to the to-be-created worker processes correspondingly, comprises:
determining a shared graphics card memory allocated for the to-be-created worker processes, wherein the shared graphics card memory is a graphics card memory used for being shared between respective worker processes; and
configuring the shared graphics card memory to the to-be-created worker processes.

14. The electronic device of claim 12, wherein the creating the plurality of worker processes, comprises:
determining a central processing unit resource and a memory resource for supporting the running of the worker processes; and
configuring, by using a preset resource configuration ratio, the graphics processor resource for supporting the running of the worker processes, and the central processing unit resource and the memory resource for supporting the running of the worker process to the to-be-created worker processes correspondingly, to create the plurality of worker processes,
wherein the preset resource configuration ratio is a resource configuration ratio between the graphics processor resource and the central processing unit resources and the memory resource.

15. A non-transitory computer-readable storage medium storing computer instructions, wherein the computer instructions, when executed by a computer, cause the computer to perform operations of:
determining a plurality of data processing tasks of a target application for a graphics processor; and
allocating, by using a load balancing strategy, the plurality of data processing tasks to a plurality of worker processes created for the target application, wherein the plurality of worker processes are pre-configured with a corresponding graphics processor resource.

16. The non-transitory computer-readable storage medium of claim 15, wherein the allocating, by using the load balancing strategy, the plurality of data processing tasks to the plurality of worker processes created for the target application, comprises:
allocating, by using a polling strategy, the plurality of data processing tasks to the plurality of worker processes according to a task generation sequence corresponding to the plurality of data processing tasks.

17. The non-transitory computer-readable storage medium of claim 15, wherein the determining the plurality of data processing tasks of the target application for the graphics processor, comprises: determining a data processing task, related to a session control, of the plurality of data processing tasks; and
the allocating the plurality of data processing tasks to the plurality of worker processes created for the target application, comprises:
allocating the data processing task related to the session control to a designated worker process among the plurality of worker processes.

18. The non-transitory computer-readable storage medium of claim 15, wherein the determining the plurality of data processing tasks of the target application for the graphics processor, comprises:
acquiring an application service request, for the graphics processor, sent by the target application; and
splitting the application service request into the plurality of data processing tasks according to a predetermined splitting rule.

19. The non-transitory computer-readable storage medium of claim 15, before allocating the plurality of data processing tasks to the plurality of worker processes created for the target application, the computer instructions, when executed by the computer, cause the computer to perform further operations of:
determining the graphics processor resource for supporting running of the worker processes;
determining to-be-created worker processes for the target application based on the graphics processor resource for supporting the running of the worker processes; and
configuring the graphics processor resource for supporting the running of the worker processes to the to-be-created worker processes correspondingly, to create the plurality of worker processes.

20. The non-transitory computer-readable storage medium of claim 19, wherein in a case where the graphics processor resource for supporting the running of the worker processes comprises a graphics card memory, the configuring the graphics processor resource for supporting the running of the worker processes to the to-be-created worker processes correspondingly, comprises:
determining a shared graphics card memory allocated for the to-be-created worker processes, wherein the shared graphics card memory is a graphics card memory used for being shared between respective worker processes; and
configuring the shared graphics card memory to the to-be-created worker processes.
